(19) United States
(12) Patent Application Publication
(10) Pub. No.: US 2026/0003625 A1
(43) Pub. Date: Jan. 1, 2026

(54) SELECTIVE CONTROL MODE PROCESSING

(71) Applicant: INTERNATIONAL BUSINESS MACHINES CORPORATION, Armonk, NY (US)

(72) Inventors: Louis P. GOMES, Poughkeepsie, NY (US); Timothy J. SLEGEL, Staatsburg, NY (US)

(21) Appl. No.: 18/756,558

(22) Filed: Jun. 27, 2024

(51) Int. Cl. G06F 9/30; G06F 9/38

(52) U.S. Cl. CPC G06F 9/30185; G06F 9/30145; G06F 9/30181; G06F 9/30189

(57) ABSTRACT

An instruction includes a control mode indicator and is executed to perform an action defined by the instruction. Execution of the instruction includes checking the control mode indicator and re-defining, based on the control mode indicator being a selected value, one or more instruction areas used by the instruction to provide other functionality of the instruction. The action defined by the instruction is performed using at least a portion of the other functionality provided by the re-defining the one or more instruction areas.

### BACKGROUND

One or more aspects relate, in general, to processing within a computing environment, and in particular, to instruction execution within the computing environment.

Instructions are issued by computer code or programs and executed by processors to perform certain actions (e.g., tasks, operations, functions, etc.). For instance, cryptographic instructions are used to implement cryptographic algorithms and perform cryptographic functions, which are used for the protection of data. There are a number of cryptographic functions, including various cryptographic hash functions, such as SHA-3 (Secure Hash Algorithm 3) and SHAKE (SHA Keccak), as examples, that may be used to protect data. SHAKE is a variable length hash function that is based on the Keccak algorithm.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one computing device to perform computer operations. The computer operations include executing an instruction to perform an action defined by the instruction. The instruction includes a control mode indicator and the executing the instruction includes checking the control mode indicator. Based on the control mode indicator being a selected value, one or more instruction areas used by the instruction are re-defined to provide other functionality of the instruction. The action defined by the instruction is performed using at least a portion of the other functionality provided by the re-defining of the one or more instruction areas.

In one or more aspects, a computer program product is provided. The computer program product includes a set of one or more computer-readable storage media and program instructions, collectively stored in the set of one or more computer-readable storage media, for causing at least one computing device to perform computer operations. The computer operations include executing an instruction to perform an action defined by the instruction. The instruction includes a control mode indicator, and the executing the instruction includes determining an execution mode of the instruction, based on the control mode indicator. The determining the execution mode includes checking the control mode indicator and selecting the execution mode of the instruction from a plurality of execution modes based on a value of the control mode indicator. Processing of the instruction is performed based on the execution mode that is determined.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2 depicts one example of further details of a processor of the processor set of FIG. 1, in accordance with one or more aspects of the present disclosure;

FIG. 3 depicts one example of the control mode processing code of FIG. 1, in accordance with one or more aspects of the present disclosure;

FIG. 4A depicts one example of a format of a Compute Last Message Digest instruction, in accordance with one or more aspects of the present disclosure;

FIG. 4B depicts one example of a mask field used by the Compute Last Message Digest instruction of FIG. 4A, in accordance with one or more aspects of the present disclosure;

FIGS. 4C-4F depict examples of contents of registers used by the Compute Last Message Digest instruction of FIG. 4A, in accordance with one or more aspects of the present disclosure;

FIGS. 4G-4H depict examples of contents of general registers used by the Compute Last Message Digest instruction of FIG. 4A, in accordance with one or more aspects of the present disclosure;

FIG. 4I depicts one example of a parameter block used by the Compute Last Message Digest instruction of FIG. 4A, in accordance with one or more aspects of the present disclosure;

FIG. 5 depicts one example of control mode processing, in accordance with one or more aspects of the present disclosure; and

FIGS. 6A-6B depict another example of a computing environment to incorporate and use one or more aspects of the present disclosure.

### DETAILED DESCRIPTION

In accordance with one or more aspects of the present disclosure, a capability is provided to facilitate processing within a computing environment. For instance, processing is facilitated by providing control mode processing, in which one execution mode of a plurality of execution modes is selected and used for processing. In one or more aspects, text of an instruction (e.g., a control mode indicator of the instruction) is used to selectively control processing of the instruction, including use of selected instruction areas (e.g., fields, bits, storage areas, etc.) used by the instruction.

In one or more aspects, a single instruction (e.g., a compute message digest instruction, such as a compute last message digest instruction, other compute message digest instructions, or other instruction) is provided that encodes controls used in control mode processing. In one example, the single instruction is executed in hardware (e.g., using at least one hardware accelerator). Other examples are possible.

In one or more aspects, certain instructions, such as architected cryptographic instructions that implement cryptographic algorithms and/or other types of instructions, are defined within an architecture to use selected instruction areas (such as bits or fields of registers (e.g., general registers)) for input and output information. In one example architecture, unused instruction areas (e.g., bits and/or fields of the registers) are defined as ignored which allows the computer code or program executing the instruction to include any value in the unused instruction areas. This may be an issue if those unused instruction areas are to be used in the future to define, e.g., new fields to support new architectural enhancements. In such a case, the machine (e.g., computing device, such as a processor) may be unable to determine if the program is updated to incorporate new architectural support, and therefore, providing meaningful input in the new field or if the program is not aware of the new architectural enhancements (i.e., a legacy program) and providing invalid data (e.g., uninitialized storage, random number, etc.) in the ignored bits, which would produce undesired results.

Therefore, in accordance with one or more aspects, a capability is provided that enables the architecture to re-define instruction areas (e.g., bits, fields, storage, etc.) used by an instruction. As an example, new bits or fields are defined over currently ignored bits or fields; however, programs are provided with both legacy support to operate in compatibility mode and new architecture enhancements support to operate in enhanced mode concurrently on the same machine model. For instance, instructions include a control mode indicator that is used to re-define one or more instruction areas providing an enhanced execution mode or is used to bypass the re-defining providing compatibility mode. Other examples are possible.

In one or more aspects, a computer program product is provided. The computer program product includes a set of one or more computer-readable storage media and program instructions, collectively stored in the set of one or more computer-readable storage media, for causing at least one computing device to perform computer operations. The computer operations include executing an instruction to perform an action defined by the instruction. The instruction includes a control mode indicator and the executing the instruction includes checking the control mode indicator. Based on the control mode indicator being a selected value, one or more instruction areas used by the instruction are re-defined to provide other functionality of the instruction. The action defined by the instruction is performed using at least a portion of the other functionality provided by the re-defining the one or more instruction areas. By including the control mode indicator with the instruction, multiple functionalities (e.g., multiple facilities, features, functions, etc.) are configured for the instruction enabling the instruction to be used in an enhanced capacity for future expansion, as well as being backwards compatible.

Additionally, or alternatively, in one example, at least one instruction area of the one or more instruction areas is defined as to be ignored prior to the re-defining. By including the control mode indicator with the instruction, and re-defining instruction areas defined as ignored, multiple functionalities (e.g., multiple facilities, features, functions, etc.) are configured for the instruction enabling the instruction to be used in an enhanced capacity for future expansion, as well as being backwards compatible.

Additionally, or alternatively, in one example, the one or more instruction areas include one or more fields used by the instruction. This enables a re-defining of one or more fields or parts of the fields that were previously not usable to enable enhanced processing, as well as continuing to provide backwards compatibility.

Additionally, or alternatively, in one example, the re-defining the one or more instruction areas includes changing one or more ignored bits of the one or more fields of the instruction to one or more usable bits. This enables a re-defining of one or more fields or parts of the fields that were previously not usable to enable enhanced processing, as well as continuing to provide backwards compatibility.

Additionally, or alternatively, in one example, the one or more usable bits include one or more assigned bits. Use of the control mode indicator enables the architecture to define additional registers and storage area bits and fields as assigned for current and future expansion with backwards compatibility.

Additionally, or alternatively, in one example, the one or more usable bits include one or more reserved bits. Use of the control mode indicator enables the architecture to define additional registers and storage area bits and fields as reserved for current and future expansion with backwards compatibility.

Additionally, or alternatively, in one example, the one or more instruction areas include at least a portion of a storage area used by the instruction. This enables a re-defining of at least a portion of a storage area to enable enhanced processing, as well as continuing to provide backwards compatibility.

Additionally, or alternatively, in one example, the computer operations further include executing another instance of the instruction. The executing the another instance of the instruction includes bypassing the re-defining, based on the control mode indicator being set to another selected value, and performing the action in which the use of the at least a portion of the other functionality is suppressed. By using the control mode indicator, the instruction is selectively enabled to suppress the use of other functionalities. The instruction is able to suppress newer facilities support that uses non-compatible registers and affected storage area formats and contents until the program acknowledges, e.g., via the control mode indicator, that it knows about the new format. This provides backwards compatibility (i.e., legacy mode support).

Additionally, or alternatively, in one example, the executing the instruction and the executing the another instance of the instruction are performed by a same processor. Enabling instances of the instruction to switch between multiple modes concurrently (e.g., by various settings of the control mode indicator) at execution time on the same machine configuration provides concurrent multi-mode support. A program with only legacy support is enabled to operate in compatibility mode, while another program with new architecture enhancements support may operate in a new enhanced mode concurrently at execution time on the same machine configuration.

Additionally, or alternatively, in one example, the control mode indicator is set by a compiler at compile time. This improves software performance. By allowing the compiler to set the indicator at compile time eliminates extra code and execution time to determine and alter the instruction.

Additionally, or alternatively, in one example, the control mode indicator is included in a text field of the instruction. By including the control mode indicator within the instruction itself, multiple functionalities (e.g., multiple facilities, features, functions, etc.) are enabled for the instruction enabling the instruction to be used in an enhanced capacity for future expansion, as well as being backwards compatible. The instruction provides future enhancements while providing backwards compatibility in the new mode.

In accordance with one or more aspects, each of the embodiments is separable and optional from one another. Further, embodiments may be combined with one another.

In one or more aspects, a computer system is provided. The computer system includes at least one computing device, a set of one or more computer-readable storage media, and program instructions, collectively stored in the set of one or more computer-readable storage media, for causing the at least one computing device to perform computer operations. The computer operations include executing an instruction to perform an action defined by the instruction. The instruction includes a control mode indicator, and executing the instruction includes checking the control mode indicator. Based on the control mode indicator being a selected value, one or more instruction areas used by the instruction are re-defined to provide other functionality of the instruction. The action defined by the instruction is performed using at least a portion of the other functionality provided by the re-defining the one or more instruction areas. By including the control mode indicator with the instruction, multiple functionalities (e.g., multiple facilities, features, functions, etc.) are configured for the instruction enabling the instruction to be used in an enhanced capacity for future expansion, as well as being backwards compatible.

Additionally, or alternatively, in one example, at least one instruction area of the one or more instruction areas is defined as to be ignored prior to the re-defining. By including the control mode indicator with the instruction, and re-defining instruction areas defined as ignored, multiple functionalities (e.g., multiple facilities, features, functions, etc.) are configured for the instruction enabling the instruction to be used in an enhanced capacity for future expansion, as well as being backwards compatible.

Additionally, or alternatively, in one example, the one or more instruction areas include one or more fields used by the instruction. The re-defining the one or more instruction areas includes changing one or more ignored bits of the one or more fields of the instruction to one or more usable bits. This enables a re-defining of one or more fields or parts of the fields that were previously not usable to enable enhanced processing, as well as continuing to provide backwards compatibility.

Additionally, or alternatively, in one example, the one or more instruction areas include at least a portion of a storage area used by the instruction. This enables a re-defining of at least a portion of a storage area to enable enhanced processing, as well as continuing to provide backwards compatibility.

Additionally, or alternatively, in one example, the control mode indicator is set by a compiler at compile time. This improves software performance. By allowing the compiler to set the indicator at compile time eliminates extra code and execution time to determine and alter the instruction.

In accordance with one or more aspects, each of the embodiments is separable and optional from one another. Further, embodiments may be combined with one another.

In one or more aspects, a computer-implemented method is provided. The computer-implemented method includes executing an instruction to perform an action defined by the instruction. The instruction includes a control mode indicator and executing the instruction includes checking the control mode indicator. Based on the control mode indicator being a selected value, one or more instruction areas used by the instruction are re-defined to provide other functionality of the instruction. The action defined by the instruction is performed using at least a portion of the other functionality provided by the re-defining the one or more instruction areas. By including the control mode indicator with the instruction, multiple functionalities (e.g., multiple facilities, features, functions, etc.) are configured for the instruction enabling the instruction to be used in an enhanced capacity for future expansion, as well as being backwards compatible.

Additionally, or alternatively, in one example, at least one instruction area of the one or more instruction areas is defined as to be ignored prior to the re-defining. By including the control mode indicator with the instruction, and re-defining instruction areas defined as ignored, multiple functionalities (e.g., multiple facilities, features, functions, etc.) are configured for the instruction enabling the instruction to be used in an enhanced capacity for future expansion, as well as being backwards compatible.

Additionally, or alternatively, in one example, the one or more instruction areas include one or more fields used by the instruction. The re-defining the one or more instruction areas includes changing one or more ignored bits of the one or more fields of the instruction to one or more usable bits. This enables a re-defining of one or more fields or parts of the fields that were previously not usable to enable enhanced processing, as well as continuing to provide backwards compatibility.

Additionally, or alternatively, in one example, the one or more instruction areas include at least a portion of a storage area used by the instruction. This enables a re-defining of at least a portion of a storage area to enable enhanced processing, as well as continuing to provide backwards compatibility.

Additionally, or alternatively, in one example, the control mode indicator is set by a compiler at compile time. This improves software performance. By allowing the compiler to set the indicator at compile time eliminates extra code and execution time to determine and alter the instruction.

In accordance with one or more aspects, each of the embodiments is separable and optional from one another. Further, embodiments may be combined with one another.

In one or more aspects, a computer program product is provided. The computer program product includes a set of one or more computer-readable storage media, and program instructions, collectively stored in the set of one or more computer-readable storage media, for causing at least one computing device to perform computer operations. The computer operations include executing an instruction to perform an action defined by the instruction. The instruction includes a control mode indicator and executing the instruction includes determining an execution mode of the instruction, based on the control mode indicator. The determining the execution mode includes checking the control mode indicator, and selecting the execution mode of the instruction from a plurality of execution modes based on a value of the control mode indicator. Processing of the instruction is performed based on the execution mode that is determined. By including the control mode indicator with the instruction, multiple functionalities (e.g., multiple facilities, features, functions, etc.) are configured for the instruction enabling the instruction to be used in an enhanced capacity for future expansion, as well as being backwards compatible. Execution mode is selectively determined based on the control mode indicator.

Additionally, or alternatively, in one example, the plurality of execution modes includes a compatibility mode and an enhanced execution mode. By selecting from a plurality of execution modes, processing is enhanced, flexibility is provided and performance is improved.

In accordance with one or more aspects, each of the embodiments is separable and optional from one another. Further, embodiments may be combined with one another.

In one or more aspects, a computer-implemented method is provided. The computer-implemented method includes executing an instruction to perform an action defined by the instruction. The instruction includes a control mode indicator. The executing the instruction includes, for instance, determining an execution mode of the instruction, based on the control mode indicator. The determining the execution mode includes checking the control mode indicator, and selecting the execution mode of the instruction from a plurality of execution modes based on a value of the control mode indicator. Processing of the instruction is performed based on the execution mode that is determined. By including the control mode indicator with the instruction, multiple functionalities (e.g., multiple facilities, features, functions, etc.) are configured for the instruction enabling the instruction to be used in an enhanced capacity for future expansion, as well as being backwards compatible. Execution mode is selectively determined based on the control mode indicator.

Additionally, or alternatively, in one example, the plurality of execution modes includes a compatibility mode and an enhanced execution mode. By selecting from a plurality of execution modes, processing is enhanced, flexibility is provided and performance is improved.

In one or more aspects, a computer program product is provided. The computer program product includes a set of one or more computer-readable storage media and program instructions, collectively stored in the set of one or more computer-readable storage media, for causing at least one computing device to perform computer operations. The computer operations include executing an instruction to perform an action defined by the instruction. The instruction includes a control mode indicator and the executing the instruction includes checking the control mode indicator. Based on the control mode indicator being a selected value, one or more instruction areas used by the instruction are re-defined to provide other functionality of the instruction. The action defined by the instruction is performed using at least a portion of the other functionality provided by the re-defining the one or more instruction areas. The control mode indicator is set by a compiler at compile time, and the control mode indicator is included in a text field of the instruction. The computer operations further include executing another instance of the instruction. The executing the another instance of the instruction includes bypassing the re-defining, based on the control mode indicator being set to another selected valuc, and performing the action in which the use of the at least a portion of the other functionality is suppressed. By using the control mode indicator, the instruction is selectively enabled to suppress the use of other functionalities. The instruction is able to suppress newer facilities support that uses non-compatible registers and affected storage area formats and contents until the program acknowledges, e.g., via the control mode indicator, that it knows about the new format. This provides backwards compatibility (i.e., legacy mode support). By including the control mode indicator with the instruction, multiple functionalities (e.g., multiple facilities, features, functions, etc.) are configured for the instruction enabling the instruction to be used in an enhanced capacity for future expansion, as well as being backwards compatible. This improves software performance. By allowing the compiler to set the indicator at compile time eliminates extra code and execution time to determine and alter the instruction.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that performs control mode processing including selective control mode processing and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

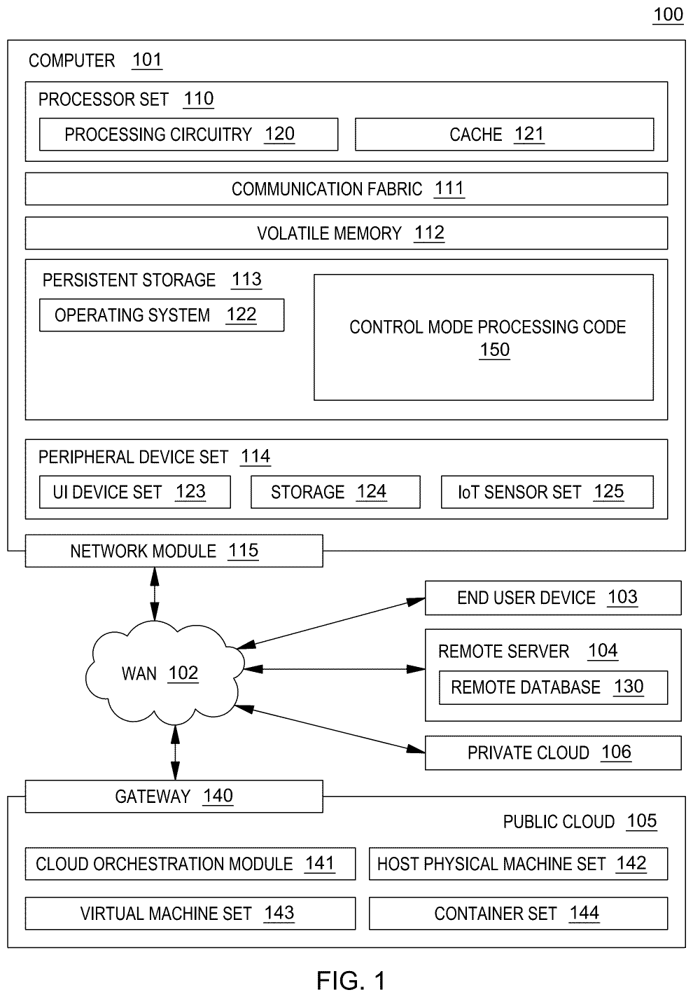

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as control mode processing code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

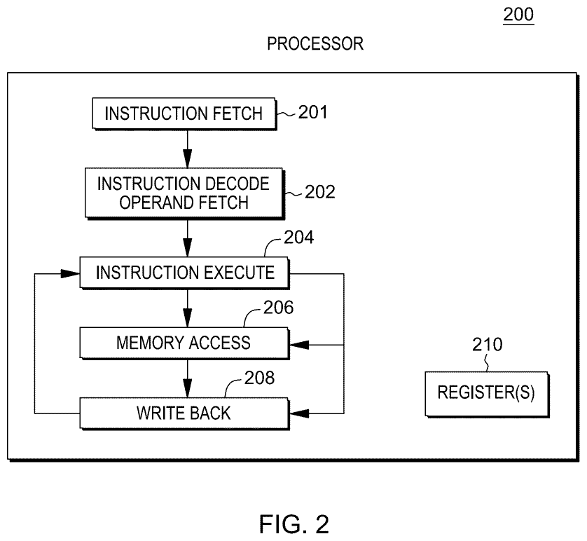

In one example, a processor (e.g., of processor set 110) includes a plurality of functional components (or a subset thereof) used to execute instructions. As depicted in FIG. 2, in one example, a processor 200 includes, for instance, an instruction fetch component 201 to fetch instructions to be executed; an instruction decode/operand fetch component 202 to decode the fetched instructions and to obtain operands of the decoded instructions; one or more instruction execute components 204 to execute the decoded instructions; a memory access component 206 to access memory for instruction execution, if necessary; and a write back component 208 to provide the results of the executed instructions. One or more of the components may access and/or use one or more registers 210 in instruction processing. Further, one or more of the components may access and/or use control mode processing code 150. Additional, fewer and/or other components may be used in one or more aspects of the present disclosure.

In one example, control mode processing code (e.g., control mode processing code 150) includes code to be used to selectively control use of selected instruction areas used by an instruction. The code is, e.g., computer-readable program code (e.g., instructions) in computer-readable storage media, e.g., storage (persistent storage 113, cache 121, storage 124, other storage, as examples). The computer-readable storage media may be part of one or more computer program products and the computer-readable program code may be executed by and/or using one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; one or more hardware accelerators separate and/or part of one or more processors and/or processing circuitry; and/or other computing devices, etc.). Additional and/or other computers, servers, devices, processors, nodes, processing circuitry, accelerators and/or computing devices may be used to execute the code and/or portions thereof. Many examples are possible.

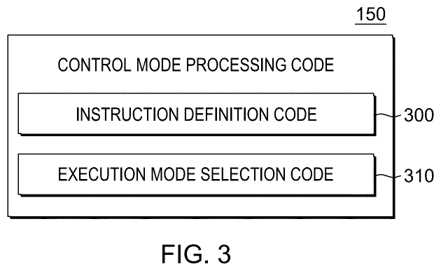

One example of control mode processing code 150 is described with reference to FIG. 3. In one example, control mode processing code 150 includes instruction definition code 300 to be used to define an instruction including the setting of a control mode indicator of the instruction, and execution mode selection code 310 to be used to selectively control use of selected instruction areas (e.g., bits, fields, storage areas, etc.) used by an instruction based on execution of the instruction and the setting of the control mode indicator.

Examples of instructions to use control mode processing are cryptographic instructions, such as a compute last message digest instruction and a compute intermediate message digest instruction; however, other instructions may also use control mode processing, including other cryptographic instructions, as well as non-cryptographic instructions. Many examples are possible.

In one example, a compute last message digest instruction, such as a Compute Last Message Digest instruction, or a compute intermediate message digest instruction, such as a Compute Intermediate Message Digest instruction, is a single architected hardware machine instruction at the hardware/software interface. As an example, each instruction is part of an instruction set architecture. One example of an instruction set architecture to incorporate and/or use a compute last message digest instruction, a compute intermediate message digest instruction, other instructions and/or aspects of the present disclosure is the z/Architecture® instruction set architecture offered by International Business Machines Corporation, Armonk, New York. One embodiment of the z/Architecture instruction set architecture is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present disclosure. z/Architecture and IBM are trademarks or registered trademarks of International Business Machines Corporation in at least one jurisdiction.

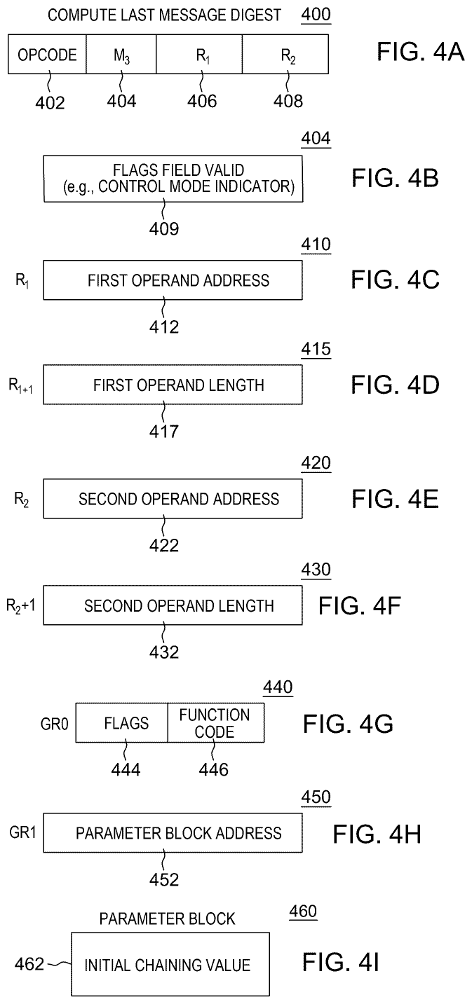

In one example, referring to FIG. 4A, a compute last message digest instruction, such as a Compute Last Message Digest instruction 400, has a format, referred to as a register and register with an extended operation code (opcode) format, having, e.g., 32 bits. The instruction includes, for instance, an operation code field 402 (e.g., bits 0-15); a mask field (M₃) 404 (e.g., bits 16-19); one register field (R₁) 406 (e.g., bits 24-27); and another register field (R₂) 408 (e.g., bits 28-31). Although in this example there is one opcode field 402, in other examples, there may be more than one opcode field. For instance, there may be one opcode field at the beginning of the instruction format and one opcode field at the end of the instruction format. Other examples are also possible.

In one example, when, e.g., a selected facility, such as the message security assist extension 12, is not installed, bits 16-19, the M₃ field, of the instruction are reserved. In one example, bits 20-23 of the instruction are reserved. Further, in one example, the instruction is configured to perform a plurality of functions, and for certain functions, the R₁ field is reserved. Reserved fields should contain, e.g., zeros; otherwise, the program may not operate compatibly in the future. Although reference is made to one or more selected facilities, such as message security assist extensions, in describing the instruction, in other examples, such a reference is not made and/or other extensions and/or facilities may be referenced. Many examples are possible.

In one example, when the selected facility, e.g., message security assist extension 12, is installed and a selected bit (e.g., bit 0) of the M₃ field is, e.g., one, the flags field is defined in, e.g., bit positions 48-55 of general register 0.

For instance, referring to FIG. 4B, M₃ field 404 includes:
Flags field valid 409: The flags field valid indicator (e.g., bit, such as bit 0) controls whether the flags field in general register 0 is valid. When the flags field valid bit is, e.g., zero, the flags field is not valid. When the flags field valid bit is, e.g., one, the flags field is valid.
In accordance with one or more aspects, the flags field valid flag is a control mode indicator used to determine whether selected instruction areas used by the instruction have been re-defined from, e.g., ignored (or another state) to usable (e.g., reserved, assigned (also referred to as defined), a different state, etc.). If, for instance, the control mode indicator (e.g., flags field valid flag) is set to a selected value, e.g., one, or more selected instruction areas are re-defined.
In one or more examples herein, the re-defining includes, re-defining bit positions 32-55 of general register 0. For instance, bits 32-47 are re-defined from ignored to reserved, allowing the bits to be used to provide further functionality of the instruction; and bits 48-55 are re-defined by assigning a flags field to those bits. Other examples are possible.
Bits 1-3 are reserved and should contain zeros; otherwise, the program may not operate compatibly in the future.

In one example, referring to FIGS. 4A and 4C, register field (R₁) 406 specifies a register 410 (R₁) that includes a first operand address 412 of a first operand of the instruction. Referring to FIG. 4D, another register 415 (R₁+1) includes a length 417 of the first operand. In one example, the Compute Last Message Digest instruction is configured to perform a plurality of functions; however, in one example, only particular functions use the R₁ field. For instance, the Compute Last Message Digest-SHAKE-128 function and the Compute Last Message Digest-SHAKE-256 function of the instruction use the R₁ field 406; other functions do not use R₁ field 406. Other examples are possible.

In one example, the R₁ field designates an even-odd pair of general registers and is to designate an even-numbered register other than, e.g., general register 0; otherwise, a specification exception is recognized, in one example. In other examples, other types of registers other than general registers may be used. Further, registers other than even-numbered registers may be designated. Many examples are possible.

In one example, referring to FIGS. 4A and 4E, register field (R₂) 408 specifies a register 420 (R₂) that includes a second operand address 422 of a second operand of the instruction. Referring to FIG. 4F, another register 430 (R₂+1) includes a length 432 of the second operand.

In one example, the R₂ field designates an even-odd pair of general registers and is to designate an even-numbered register other than, e.g., general register 0; otherwise, a specification exception is recognized, in one example. In other examples, other types of registers other than general registers may be used. Further, registers other than even-numbered registers may be designated. Many examples are possible.

In one example, the location of the leftmost byte of the second operand is specified by the contents of the R₂ general register. The number of bytes in the second operand location is specified in, e.g., general register R₂+1.

As part of the operation, the address in general register R₂ is incremented by the number of bytes processed from the second operand, and the length in general register R₂+1 is decremented by the same number. The formation and updating of the addresses and length is dependent on, for instance, the addressing mode.

In, for instance, the 24-bit addressing mode, the contents of bit positions 40-63 of general register R₂ constitute the address of the second operand, and the contents of bit positions 0-39 are disregarded; bits 40-63 of the updated address replace the corresponding bits in general register R₂, carries out of, e.g., bit position 40 of the updated address are disregarded, and the contents of bit positions 32-39 of general register R₂ are set to, e.g., zeros. In the 31-bit addressing mode, the contents of bit positions 33-63 of general register R₂ constitute the address of the second operand, and the contents of bit positions 0-32 are disregarded; bits 33-63 of the updated address replace the corresponding bits in general register R₂, carries out of, e.g., bit position 33 of the updated address are disregarded, and the content of bit position 32 of general register R₂ is set to, e.g., zero. In the 64-bit addressing mode, the contents of bit positions 0-63 of general register R₂ constitute the address of the second operand; bits 0-63 of the updated address replace the contents of general register R₂, and carries out of, e.g., bit position 0 are disregarded. Other examples are possible.

In both the 24-bit and the 31-bit addressing modes, the contents of bit positions 32-63 of general register R₂+1 form a 32-bit unsigned binary integer which specifies the number of bytes in the second operand; and the updated value replaces the contents of bit positions 32-63 of general register R₂+1. In the 64-bit addressing mode, the contents of bit positions 0-63 of general register R₂+1 form a 64-bit unsigned binary integer which specifies the number of bytes in the second operand; and the updated value replaces the contents of general register R₂+1.

In the 24-bit or 31-bit addressing mode, the contents of bit positions 0-31 of general registers R₂ and R₂+1, remain unchanged, in one example.

Further, in one example, Compute Last Message Digest instruction 400 uses multiple implied general registers, such as general register 0 (GR0) and general register 1 (GR1). These registers are referred to as implied registers since they are not explicitly referenced by one or more fields of the instruction; however, they are used by the instruction. Examples of the registers are described below.

In one example referring to FIG. 4G, a general register 0 (440) includes, for instance:
Flags 444 (e.g., bits 48-55): In one example, bit positions 48-55 of general register 0 contain an 8-bit flags field controlling an operation of the function. The flags field and/or certain flags is/are meaningful for selected function codes of the instruction, as described herein. In one example, bits 0-6 are meaningful when, e.g., a selected facility, e.g., a message security assist extension 12, is installed, bit 0 of the M₃ field is, e.g., one, and the function code in bits 57-63 of general register 0 designates a specific function (as described with reference to the flags). Bit 7 is meaningful when, e.g., the message security assist extension 6 is installed, and the function code in bits 57-63 of general register 0 designates a specific function (as described with reference to the flags). Any bit of the flags field that is not applicable to the specified function is reserved and should contain a zero; otherwise, the program may not operate compatibly in the future.
Although one or more message security assist extensions are mentioned, in other examples, one or more of these extensions may not be considered for flag control, and/or other functions and/or facilities may be considered. Many examples are possible.
One example format of the flags field is as follows:
No-ICV Provided (NIP): In one example, bit 0 of the flags field indicates whether the initial chaining value (ICV) value is provided by the program in the parameter block. The No-ICV provided flag is meaningful, e.g., when the function code in bits 57-63 of general register 0 of the Compute Last Message Digest instruction designates, e.g., a SHA-3 or SHAKE function code (e.g., function codes 32-37).
When the no-ICV provided flag is a selected value (e.g., zero), the initial chaining value provided by the program in the parameter block is used as the initial chaining value; otherwise, if the no-ICV provided flag is another selected value (e.g., one), a default value, such as zeros, in one example, are used as the initial chaining value.
Discard unneeded final output chaining value (OCV) part (DUFOP): In one example, bit 1 of the flags field indicates whether the unneeded portion of the final output chaining value is saved in the parameter block. The discard unneeded final output chaining value part flag is meaningful, e.g., when the function code in bits 57-63 of general register 0 of the Compute Last Message Digest instruction designates, e.g., a SHA-3 or SHAKE function code (e.g., function codes 32-37).
When the discard unneeded final output chaining value part flag is a selected value (e.g., one) and the instruction completes with condition code, e.g., 0, the unneeded portion of the final output chaining value is not necessarily saved in the parameter block. For this case, it is model dependent if the unneeded portion of the final output chaining value is saved in the parameter block. When the discard unneeded final output chaining value part flag is another selected value (e.g., zero) and the instruction completes with condition code, e.g., 0, the entire output chaining value is saved in the parameter block.
Padding State (PS): In one example, bit 7 of the flags field indicates whether the padding of the second operand has been performed. The padding state flag is meaningful, e.g., when the function code is bits 57-63 of general register 0 of the Compute Last Message Digest instruction designates, e.g., a SHA-3 or SHAKE function code (e.g., function codes 32-37).
When the padding state flag is, e.g., zero, the padding of the second operand has not yet been performed; otherwise, the padding of the second operand has been performed.
Reserved: In one example, bits 2-6 of the flags field are reserved and should contain, e.g., zeros; otherwise, the program may not operate compatibly in the future.

General 0 further includes, for instance:

Function code 446 (e.g., bits 57-63): In one example, bit positions 57-63 of general register 0 include the function code that specifies a function to be performed by the Compute Last Message Digest instruction. The instruction is configured to specify and implement a plurality of functions and respective function codes. Example function codes include, for instance, a function code (e.g., function code 32) that specifies a Compute Last Message Digest (KLMD)-SHA3-224 function; a function code (e.g., function code 33) that specifies a Compute Last Message Digest-SHA3-256 function; a function code (e.g., function code 34) that specifies a Compute Last Message Digest-SHA3-384 function; a function code (e.g., function code 35) that specifies a Compute Last Message Digest-SHA3-512 function; a function code (e.g., function code 36) that specifies a Compute Last Message Digest-SHAKE-128 function; and a function code (e.g., function code 37) that specifies a Compute Last Message Digest-SHAKE-256 function, etc. Although example functions and/or function codes may be specified, additional, fewer and/or other functions/function codes may be specified and/or used. Many examples are possible.

Further, in one example, one or more selected bits, e.g., bit 56 of general register 0 is to be, e.g., zero; otherwise, a specification exception is recognized, in one example. Bit positions 0-31 of general register 0 are ignored, in one example. When bit 0 of the M₃ field is, e.g., zero, bit positions 32-55 of general register 0 are ignored. However, in accordance with one or more aspects, when bit 0 of the M₃ field is, e.g., one, (i.e., the control mode indicator is set to a selected value), bit positions 32-47 of general register 0 are reserved and are to contain, e.g., zeros; otherwise, the program may not operate compatibly in the future. Thus, in accordance with one or more aspects, based on the control mode indicator (e.g., flags field valid flag 409) being set to a selected value (e.g., 1), one or more instruction areas (e.g., bits 32-47 of GR0) are re-defined from ignored to reserved, allowing those bits to provide other functionality that may be used by the instruction. Further, one or more other instruction areas (e.g., bits 48-55 of GR0) are re-defined to include a flags field used to provide other functionality of the instruction. For instance, when bit 0 of the M₃ field is, e.g., one, a flags field of general register 0 is used and contains additional operation controls, as described herein. The re-defining of the instruction areas allows the instruction to be executed in an enhanced execution mode in which functionality may be added to the instruction (e.g., by using those instruction areas) that is unavailable if those instruction areas are not re-defined.

In one example, when, for instance, a selected facility, e.g., message security assist extension 6, is installed, the padding state flag is defined in bit position 55 of general register 0; otherwise, bit position 55 of general register 0 is not used.

One example of general register 1 is depicted in FIG. 4H. In one example, a general register 1 (450) includes an address 452 of a parameter block in storage (e.g., memory, storage, etc.). For instance, address 452 is a logical address of, for instance, a leftmost byte of the parameter block in storage. In one example, the location of the address in the general register depends on the addressing mode. For instance, in the 24-bit addressing mode, the contents of bit positions 40-63 of general register 1 constitutes the address, and the contents of bit positions 0-39 are disregarded. In the 31-bit addressing mode, the contents of bit positions 33-63 of general register 1 constitute the address, and the contents of bit positions 0-32 are disregarded. In the 64-bit addressing mode, the contents of bit positions 0-63 of general register 1 constitute the address. Other examples are possible.

One example of a parameter block used by the Compute Last Message Digest instruction for selected functions is described with reference to FIG. 4I. In one example, a parameter block, e.g., a parameter block 460, includes, for instance, an initial chaining value (ICV) 462. The initial chaining value (ICV) represents a 1600-bit state array used by, for instance, the Keccak[c] functions which implement the SHA-3 algorithms.

The parameter block may include additional, fewer and/or other information. Other examples and variations are possible.

In accordance with an aspect of the present disclosure, the parameter block may be another instruction area in which a selected portion is defined as assigned or reserved to be used for enhanced execution mode processing. Other examples are also possible.

In one example, a query function of the instruction provides the means of indicating the availability of other functions of the instruction. The contents of general registers R₁, R₁+1, R₂ and R₂+1 are disregarded for the query function, in one example.

For other functions of the instruction, the second operand is processed as specified by the function code using an initial chaining value (ICV) in the parameter block either when the specified function code is not a SHA-3 or SHAKE function, or when the specified function code is a SHA-3 or SHAKE function and the no-initial chaining value provided flag is, e.g., zero, and the result replaces the chaining value. The operation proceeds until the end of the second operand location is reached or a central processing unit (CPU)-determined number of bytes have been processed, whichever occurs first.

In one example, for the Compute Last Message Digest-SHAKE functions, when the end of the second operand is reached, an extended output function (XOF) digest is stored at the first operand location. The operation then proceeds until either the end of the first operand location is reached, or a CPU-determined number of bytes have been stored, whichever occurs first.

The result is indicated in the condition code resulting from execution of the instruction.

For the Compute Last Message Digest-SHAKE functions, the following applies, in one example:
A specification exception is recognized, and the operation is suppressed when the padding state (PS), bit 7 of the flags field of general register 0, is, e.g., one and the second operand length is general register R₂+1 is, e.g., nonzero at the beginning of the instruction.
A specification exception is recognized, and the operation is suppressed when the padding state flag is, e.g., one and the no-initial chaining value provided flag is, e.g., one at the beginning of the instruction.
When the remaining second operand length is, e.g., zero, the central processing unit, in one example, inspects the padding state to determine whether padding of the second operand is to be performed. The padding state flag is set to, e.g., one by the central processing unit when padding of the second operand has been performed.
The R₁ field designates an even-odd pair of general registers and is to designate an even-numbered register other than general register 0 and other than general register R₂; otherwise, a specification exception is recognized.
The location of the leftmost byte of the first operand is specified by the contents of general register R₁. The number of bytes in the first operand location is specified in general register R₁+1.
As a part of the operation, the address in general register R₁ is incremented by the number of bytes stored into the first operand, and the length in general register R₁+1 is decremented by the same number. The formation and updating of the address and length is dependent on the addressing mode.
The addressing mode characteristics for general registers R₁ and R₁+1 are the same, in one example, as those for general registers R₂ and R₂+1, respectively, as described herein.

In one example, for functions other than the SHAKE Compute Last Message Digest functions, bit 55 of general register 0 and the R₁ field of the instruction are disregarded. In this case, a first operand is not present, and general registers R₁ and R₁+1 are not modified. Other examples are possible.

In operation, a function specified by the function code in general register 0 is performed. One such function is a Compute Last Message Digest-SHAKE-128 function (e.g., function code 36). For the Compute Last Message Digest-SHAKE-128 function, when the length of the second operand in general register R₂+1 is greater than or equal to 168 bytes, the operation is as described with a Compute Intermediate Message Digest-SHAKE-128 function, except that when the remaining second operand length is less than 168 bytes.

In one example, the Compute Intermediate Message Digest instruction has a similar format to the Compute Last Message Digest instruction and may use the control mode indicator described herein; however, in one example, the Compute Intermediate Message Digest instruction does not use the padding state flag or the discard unneeded final output chaining value part flag. It may use the no-initial chaining value provided flag. Other examples are possible.

In one example, with the Compute Intermediate Message Digest-SHAKE-128 processing (and thus, the Compute Last Message Digest-SHAKE-128 function), a 200-byte intermediate message digest is generated for the 168-byte message blocks in operand 2 using, e.g., the Keccak[c] algorithm with the 200-byte initial chaining value in parameter block when the no-initial chaining value provided flag (bit 0 of the flags field in general register 0) is, e.g., zero or with 200 bytes of, e.g., zeros when the no-initial chaining value provided flag is, e.g., one. The generated intermediate message digest, also called the output chaining value (OCV), is stored in the chaining value field of the parameter block and the no-initial chaining value provided flag is set to, e.g., zero.

In one example for the Compute Last Message Digest-SHAKE-128 function, when the remaining second operand length is less than 168 bytes, the following processing is performed, in one example:
When the padding state (PS), bit 7 of the flags field of general register 0, is, e.g., zero (indicating that padding has not yet been performed), the following occurs:
In one example, any remaining bytes of the second operand are padded on the right to form a 168-byte message block. Padding occurs even when there are no remaining bytes in the second operand and does not alter the contents of the second operand. In one example, the padding is performed based on the SHA-3 10*1 padding, in which a binary one is used and then zero or more binary zeros followed by a binary one. Other padding algorithms may be used.
The padding state flag is set to, e.g., one, indicating that padding has been performed.
The second operand address in general register R₂ is incremented by the number of message bytes processed, and the second operand length in general register R₂+1 is set to, e.g., zero.
The 168-byte padded message, is exclusive ORed with the contents of the leftmost 168 bytes of the state array (from the initial chaining value in the parameter block or from the output chaining value resulting from the previous block's processing) when the no-initial chaining value provided flag (bit 0 of the flags field in general register 0) is, e.g., zero or with 168 bytes of zeros when the no-initial chaining value provided flag is, e.g., one to form an output chaining value that is used in the extended output function (XOF) processing and the no-initial chaining value provided flag is set to, e.g., zero. The rightmost 32 bytes, as an example, of the state array are unchanged.

Depending on the number of second operand blocks processed when padding is completed, either (a) the output chaining value is stored into the parameter block, and the instruction completes by setting condition code 3 (partial completion), or (b) the operation continues with extended output function processing, as described below.

When the padding state flag is, e.g., one (indicating that padding has been performed for the message, either by the current or previous execution of the instruction), extended output function processing is performed. For example:
1. If the first operand length in general register R₁+1 is, e.g., zero and the discard unneeded final output chaining value (DUFOP) flag (bit 1 of the flags field in general register 0) is, e.g., zero, then the output chaining value is stored into the parameter block, a counter in a cryptography counter set is updated when appropriate, and the instruction completes with, e.g., condition code 0. If the first operand length in general register R₁+1 is, e.g., zero and the discard unneeded final output chaining value flag is, e.g., one, then the output chaining value is not stored into the parameter block, a counter in the cryptography counter set is updated when appropriate, and the instruction completes with, e.g., condition code 0. If the first operand length is, e.g., zero at the beginning of the instruction, then it is model dependent whether the initial chaining value is fetched from the parameter block and stored back unmodified as the output chaining value when the discard unneeded final output chaining value flag is, e.g., zero.
2. The Keccak[c] function is invoked using the previous output chaining value as input and replacing the output chaining value.
3. General register R₁ contains the current address of the first operand (which includes extended output function (XOF) results), and general register R₁+1 contains the remaining length of the first operand. The number of bytes to be stored, n, is either the remaining first operand length or 168, whichever is smaller.
The first n bytes of the output chaining value are stored at the first operand location.
The first operand address in general register R₁ is incremented by n, and the first operand length general register R₁+1 is decremented by n.

Steps 1-3 of this process are repeated until the first operand length becomes, e.g., zero (in which case, a counter in the cryptography counter set is updated when appropriate and the instruction completes with, e.g., condition code 0) or until a CPU-determined number of bytes have been stored (in which case, the instruction completes with, e.g., condition code 3). The output chaining value is stored into, e.g., bytes 0-199 of the parameter block either when condition code 3 is set or when the discard unneeded final output chaining value flag is, e.g., zero and condition code, e.g., 0 is set.

The contents of the parameter block are unpredictable when, for instance, the discard unneeded final output chaining value flag is, e.g., one and the instruction completes with, e.g., condition code 0.

Although in the examples herein, certain byte sizes are described, other byte sizes may be used in other examples. Further, other size SHA block digest algorithms may be used, as well as other hash or hash-based techniques. Many examples are possible.

In one example, a specification exception is recognized, and no other action is taken if any of the following occurs:
Bit 56 of general register 0 is not zero.
Bits 57-63 of general register 0 specify an unassigned or uninstalled function code.
The R₂ field designates an odd-numbered register or general register 0.
For the KLMD-SHAKE functions, either of the following is true:
   The R₁ field designates an odd-numbered register, general register 0 or register R₂.
   The second operand length is, e.g., nonzero, and the padding state flag is, e.g., one.

Example resulting condition codes include, for instance: 0 Normal completion; 1—; 2—; 3 Partial completion.

Example program exceptions include, for instance:
Access (fetch, operand 2 and message bit length; fetch and store, chaining value, store, operand 1, cryptography counter)
Operation (if the message-security assist is not installed)
Specification
Transaction constraint

One example of execution priority is indicated below:

| | |
|---|---|
| 1.-6. | Exceptions with the same priority as the priority of program- |
| | interruption conditions for the general case. |
| 7. A | Access exceptions for second instruction halfword. |
| 7. B | Operation exception. |
| 7. C | Transaction constraint |
| 8a. | Specification exception due to invalid function code or invalid |
| | register number. |
| 8b. | Specification exception due to nonzero second operand length |
| | when the padding state flag is, e.g., one (SHAKE functions only, |
| | in one example). |
| 9. | Access exceptions for an access to the parameter block or second |
| | operand. |
| 10. | Access exceptions for an access to the first operation (SHAKE |
| | functions only, in one example). |
| 11. | Condition code 3 due to partial completion and one or more units |
| | of operation remain to be processed. |
| 12. | Access exceptions for an access to a cryptography counter and |
| | second operand length initially less than or equal to UopOpLen |
| | (micro-operation operation length) for certain SHA functions, |
| | including SHA-3, or second and first operand lengths initially |
| | less than or equal to micro-operation operation length for SHAKE |
| | functions, where micro-operation operation length is the maximum |
| | amount of second or first operand processed during a unit of |
| | operation. |
| 13. | Condition code 3 due to partial completion and second operand |
| | length initially less than or equal to micro-operation operation |
| | length for, e.g., SHA-3 functions, or second and first operand |
| | lengths initially less than or equal to micro-operation |
| | operation length for SHAKE functions, where micro-operation |
| | operation length is the maximum amount of second or first |
| | operand processed during a unit of operation. |
| 14. | Condition code 0 due to normal completion. |

In one or more aspects, if the program is to frequently test for the availability of a function, it may select to perform the query function once during initialization; subsequently it may examine the stored results of the query function in memory with an instruction such as a Test Under Mask instruction or other instruction.

In one or more aspects, for the Compute Last Message Digest-SHAKE functions, when condition code 3 is set during the extended output function, the first operand address and length in general registers R₁ and R₁+1, respectively, are updated such that the program can simply branch back to the instruction to continue the operation.

For unusual situations, the central processing unit protects against endless reoccurrence for the no-progress case. Thus, the program can safely branch back to the instruction whenever condition code 3 is set with no exposure to an endless loop.

In one or more aspects, the Compute Last Message Digest instruction does not require the second operand to be a multiple of the data block size. It first processes complete blocks and may set, e.g., condition code 3 before processing all blocks. After processing, for instance, all complete blocks, it then performs the padding operation including the remaining portion of the second operand. This may use one or two iterations of the designated block digest algorithm.

In one or more aspects, the Compute Last Message Digest instruction provides the SHA padding for messages that are a multiple of eight bits in length. If a SHA function is to be applied to a bit string which is not a multiple of eight bits, the program is to perform the SHA padding and use, e.g., the Compute Intermediate Message Digest instruction.

In one or more aspects, for the Compute Last Message Digest instruction-SHAKE functions, the following applies:
The padding state (PS), bit 7 of the flags field of general register 0, is to be set to, e.g., zero prior to the first execution of the Compute Last Message Digest instruction for a message, and the padding state is not to be altered by the program for any subsequent executions of Compute Last Message Digest instruction for the same message until normal completion occurs.
If padding of the final (short or null) block of the second operand is performed when the first operand length is, e.g., zero, then the padded block is exclusive ORed with the contents of the state array, the result is stored as the output chaining value in the parameter block when the discard unneeded final output chaining value flag is, e.g., zero, and the instruction completes with, e.g., condition code 0. The Keccak[c] function is not invoked in this case.

In one or more aspects, the Compute Last Message Digest SHA-3 and SHAKE functions perform padding according to the adopted NIST SHA-3 specification, in one example. Software that was designed according to earlier draft SHA-3 specifications can still benefit from the Compute Intermediate Message Digest SHA-3 and SHAKE functions if the software performs the padding of the last message block.

In one or more aspects, for the SHA-3 and SHAKE functions, the entire output chaining value (OCV), in one example, is stored in the parameter block after completing a unit of operation if the instruction does not complete with, e.g., condition code 0 immediately after completing the unit of operation. Other examples are possible.

In the description herein of a compute last message digest instruction, such as Compute Last Message Digest instruction 400, specific locations, specific fields and/or specific sizes of the fields may be indicated (e.g., specific bytes and/or bits). However, other locations, fields and/or sizes may be provided. Further, although the setting of a bit to a particular value, e.g., one or zero, may be specified, this is only an example. The bit, if set, may be set to a different value, such as the opposite value or to another value, in other examples. Many variations are possible.

In one embodiment, the fields of the instruction are separate and independent from one another; however, in other embodiments, more than one field may be combined. Further, although example types of registers are used, other types of registers may be used. Other examples are possible.

An instruction, such as a Compute Last Message Digest instruction, may have additional, fewer and/or other fields. For instance, one or more fields of a message digest instruction, such as the Compute Last Message Digest instruction, may be optional. Many variations are possible.

Although various examples are provided for one or more formats of the instruction, additional and/or other formats may be used. Further, the processing may be used for other purposes than described herein.

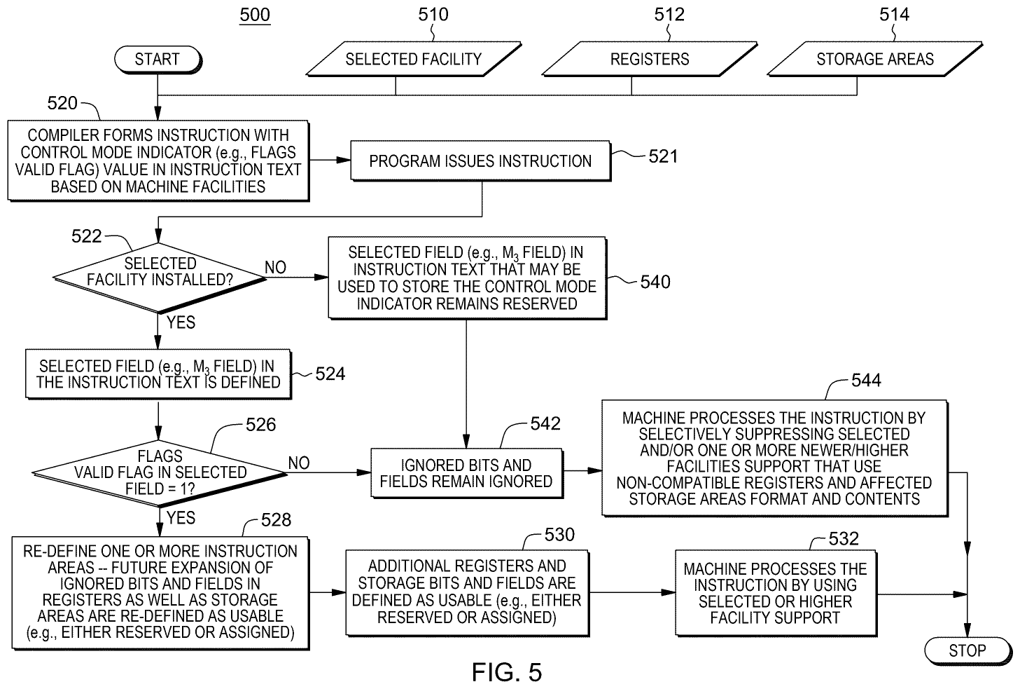

As indicated, the Compute Last Message Digest instruction and the Compute Intermediate Digest instruction are examples of instructions that may employ and benefit from control mode processing. Other examples are also possible. Further details of control mode processing are described with reference to FIG. 5. In one example, a control mode process 500 (also referred to as process 500) is executed by one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; one or more hardware accelerators separate and/or part of one or more processors and/or processing circuitry; and/or other computing devices, etc.). Additional and/or other computers, servers, devices, processors, nodes, processing circuitry, accelerators and/or computing devices may be used to execute the processing and/or aspects thereof. Many examples are possible.

Referring to FIG. 5, in one example, process 500 may have access to a selected facility 510 (e.g., message security assist extension 12 and/or other selected facility), one or more registers 512, and/or one or more storage areas 514. In one example, process 500 commences with, e.g., the compiler or a program, as examples, forming 520 an instruction (e.g., a Compute Last Message Digest instruction, Compute Intermediate Message Digest instruction and/or other instruction) with a control mode indicator, based on machine facilities. For instance, the instruction is formed with a value of flags valid flag (an example of a control mode indicator) in instruction text (e.g., M₃) being set based on machine (e.g., processor) facilities (e.g., using instruction definition code 300). As an example, if the compiler determines that a selected facility, such as the message security assist extension 12, is available and is to be used, then the control mode indicator is defined and set to, e.g., one; if, in one example, the selected facility is installed but not to be used, then the control mode indicator is defined and set to, e.g., zero; otherwise, in one example, if the selected facility is not available, the control mode indicator may not be defined and the field (e.g., M₃) is reserved. Other examples are possible.

Based on the compiler (or program) forming the instruction, process 500, via, e.g., a program, issues 521 the instruction. Process 500 determines 522 whether the selected facility (or multiple selected facilities) is installed. If the selected facility is installed, a selected field of the instruction (e.g., M₃ field) is defined 524 and includes a control mode indicator that may be used (depending on setting) to selectively control use of one or more instruction areas (e.g., fields of the instruction, bits of the instruction, one or more storage areas, etc.), as described herein.

Process 500 determines 526 whether the control mode indicator (e.g., flags valid flag value) in the selected field (M₃) is equal to a selected value, e.g., one. Should the control mode indicator (e.g., flags valid flag value) be set to the selected value, process 500 re-defines 528 one or more instruction areas (e.g., bits, fields of, e.g., registers; storage areas used by the instruction; etc.) (e.g., using execution mode selection code 310). For instance, the one or more instruction areas are re-defined from ignored to usable (e.g., reserved or assigned), enabling those instruction areas to be used to provide, e.g., other functionality usable in execution of the instruction. Further, process 500 may define 530 additional registers and storage area bits and fields as usable (e.g., reserved or assigned).

Process 500 processes 532 the instruction on a machine (e.g., a computing device) by using a selected facility (e.g., message security assist extension 12 or higher facility support). That is, the instruction may use at least a portion of the other functionality defined based on the re-defined instruction areas. For instance, for the Compute Last Message Digest instruction, certain flags are defined (e.g., in flags 444 of GR0 (440), such as the no-initial chaining value provided flag and/or the discard unneeded final output chaining value part flag) that may now be used. Other examples are possible.

Returning to inquiry 522, if the selected facility is not installed, then a selected field (e.g., the M₃ field) in the instruction text that may be used to store the control mode indicator remains reserved and does not, in this example, include the control mode indicator 540. Further, process 500 ignores 542 the ignored bits and fields of the instruction. Those instruction areas are not re-defined as usable. Process 500 processes 544 the instruction on a machine (e.g., a computing device) and selectively suppresses or bypasses use of the selected facility (e.g., message security assist extension 12 and/or one or more newer/higher facilities support) that use non-compatible registers and affected storage areas format and contents, in one example. For instance, it does not use flags field 444. Other examples are possible.

Returning to inquiry 526, should the control mode indicator (e.g., flags valid flag value) not be set to the selected value, but instead, is set to another selected value (e.g., zero), process 500 continues with processing 542.

In one or more aspects, an instruction's text (e.g., M₃ field) is used to control the instruction's non-compatible registers and storage contents by, for instance: adding an indicator (e.g., control mode indicator, such as flags valid flag) within the instruction itself to control the enablement of multiple facilities, features, functions and data within the instruction's registers and affected storage areas; enabling the compiler to set the indicator (e.g., control mode indicator, such as flags valid flag) within the instruction itself at compile time to improve software performance; enabling the instruction to suppress newer facilities support that uses non-compatible registers and affected storage areas format and contents until the program acknowledges that it knows about the new format; enabling the program to suppress a new instruction format and/or its new non-compatible registers and affected storage areas format and contents to provide backwards compatibility (legacy mode) support; enabling the instruction to switch between multiple modes (e.g., compatibility mode, enhanced execution mode) concurrently at execution time on the same machine configuration to provide multi-mode support concurrently; and/or enabling the architecture to define additional registers and storage area bits and fields as usable (e.g., reserved or assigned) for current and future expansion with future backwards compatibility. Other examples and/or variations are possible.

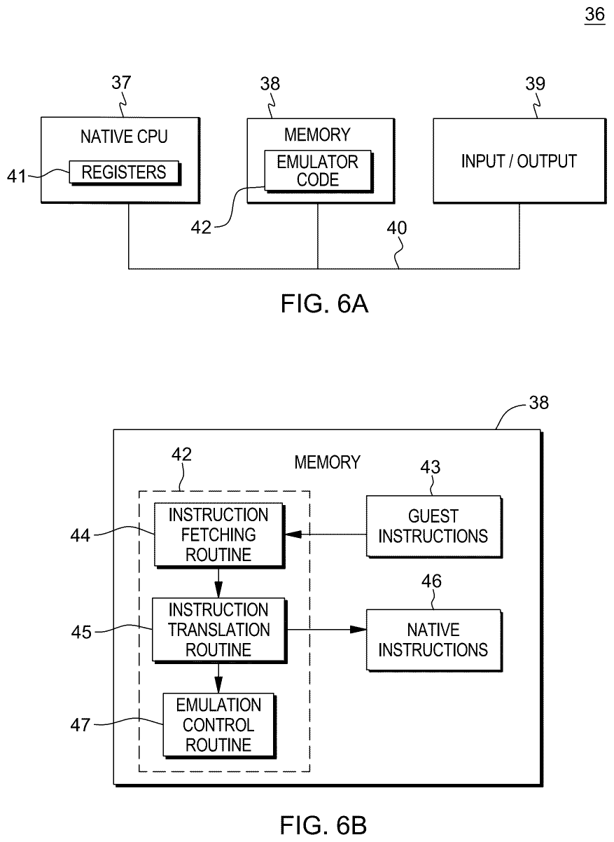

Although one or more examples of a computing environment to incorporate and use one or more aspects of the present disclosure are described herein, FIGS. 6A-6B depict another embodiment of a computing environment to incorporate and use one or more aspects of the present disclosure.

Referring, initially, to FIG. 6A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 6B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native central processing unit 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native central processing unit 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native central processing unit or by using locations in memory 38. In embodiments, guest instructions 43, native instructions 46 and emulator code 42 may reside in the same memory or may be disbursed among different memory devices.

An example instruction that may be emulated is the Compute Last Message Digest instruction and/or the Compute Intermediate Message Digest instruction described herein, in accordance with one or more aspects of the present disclosure. Other instructions are also possible.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to implement control mode processing and/or to perform one or more other aspects of the present disclosure. Software and hardware performance is improved by eliminating extra code and executing time and preventing errors (e.g., for not initializing the unused fields with zeros).

One or more aspects of the present disclosure are tied to computer technology and facilitate processing within a computer, improving performance thereof. For instance, selective control mode processing enables a single architected instruction to be selectively configured in multiple execution modes (e.g., compatibility mode—one or more instruction areas remain as is and are not re-defined; enhanced execution mode—one or more instruction areas are re-defined) providing additional functionality to the computing device, as well as saving resources and storage but minimizing the number of instructions needed to provide the additional functionality.

In accordance with one or more aspects, current usage of the instruction text (as defined in at least one architecture) includes: Numerical Value—value used as an input mask, an input number, etc.; bit string—each bit is used separately as an input flag to control a specific function. This current usage is re-defined as a new usage. The new usage includes a multi-control flag that the program acknowledges its understanding of the instruction's specific non-compatible operation mode (e.g., an enhanced execution mode) which allows the machine to use specific non-compatible new formats, flags, fields, data, etc. (e.g., re-define ignore bits, fields, etc., as usable) to implement a specific non-compatible machine architecture enhancement; and controls the enablement of other facilities, features, functions, and data within the instruction's registers and affected storage areas which is different than how it is used today.

For instance, instead of selected unused bits in the general registers of an instruction being defined as ignored which does not allow them to be used for future expansion and/or other areas, such as a parameter block, not having any reserved space to be used for future expansion, a field is added to the instruction (e.g., M₃ field) to control a new non-compatible definition of the unused bits of a general register (e.g., general register 0) that are currently defined as ignored. In one example, when the M₃ field is defined via a selected facility (e.g., message security assist extension 12) and a control mode indicator (e.g., flags valid flag) in the M₃ field is set to a selected value (e.g., one), selected bit positions (e.g., bit positions 32-47) of general register 0 are re-defined from ignored to reserved and the flag field is defined (e.g., in bit positions 48-55). Other examples are possible.

Making the selected bit positions (e.g., bit positions 32-47) of general register 0 reserved and defining the flag field in other bit positions allows these reserved/assigned bits (including the flag field) to be used for future expansion with future backwards compatibility.

In one or more aspects, an instruction's text is used to control selected non-compatible registers and storage area contents (e.g., selected registers (or parts thereof)/storage area contents not defined for use in the architecture (i.e., ignored)). An indicator (e.g., a control mode indicator) is added within the instruction, in which the indicator (e.g., control mode indicator) controls the enablement of other features, functions and/or data within the instruction's registers and affected storage areas and the indicator (e.g., control mode indicator) is set, in one example, by the compiler at compile time.

In one or more aspects, responsive to a program acknowledging the new instruction format: the program is allowed to provide backwards compatibility mode support by using the new instruction format and the new non-compatible registers and affected storage area format/contents; the program is allowed with only legacy support to operate in the compatibility mode; the program is allowed with new architecture enhancements support to operate in a new enhanced mode, concurrently, at execution time; and/or the architecture is allowed to define additional registers and storage area bits and fields as reserved or assigned for future expansion and future backwards compatibility.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Although various embodiments are described above, these are only examples. For example, other instructions, instruction formats, operands, registers and/or instruction areas may be used. Further, other cryptographic algorithms may be used. Moreover, additional, less and/or other code may be used. Although particular code may be provided as an example of performing a particular operation or task, additional and/or other code may be used. Code may be combined and/or separated into code subsets. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product comprising:
a set of one or more computer-readable storage media; and
program instructions, collectively stored in the set of one or more computer-readable storage media, for causing at least one computing device to perform computer operations including:
executing an instruction to perform an action defined by the instruction, the instruction including a control mode indicator, and wherein the executing the instruction includes:
checking the control mode indicator;
re-defining, based on the control mode indicator being a selected value, one or more instruction areas used by the instruction to provide other functionality of the instruction; and
performing the action defined by the instruction using at least a portion of the other functionality provided by the re-defining the one or more instruction areas.

2. The computer program product of claim 1, wherein at least one instruction area of the one or more instruction areas is defined as to be ignored prior to the re-defining.

3. The computer program product of claim 1, wherein the one or more instruction areas include one or more fields used by the instruction.

4. The computer program product of claim 3, wherein the re-defining the one or more instruction areas includes changing one or more ignored bits of the one or more fields of the instruction to one or more usable bits.

5. The computer program product of claim 4, wherein the one or more usable bits include one or more assigned bits.

6. The computer program product of claim 4, wherein the one or more usable bits include one or more reserved bits.

7. The computer program product of claim 1, wherein the one or more instruction areas include at least a portion of a storage area used by the instruction.

8. The computer program product of claim 1, wherein the computer operations further comprise executing another instance of the instruction, wherein the executing the another instance of the instruction includes bypassing the re-defining, based on the control mode indicator being set to another selected value, and performing the action in which the use of the at least a portion of the other functionality is suppressed.

9. The computer program product of claim 8, wherein the executing the instruction and the executing the another instance of the instruction are performed by a same processor.

10. The computer program product of claim 1, wherein the control mode indicator is set by a compiler at compile time.

11. The computer program product of claim 1, wherein the control mode indicator is included in a text field of the instruction.

12. A computer system comprising:
at least one computing device;
a set of one or more computer-readable storage media; and
program instructions, collectively stored in the set of one or more computer-readable storage media, for causing the at least one computing device to perform computer operations including:
executing an instruction to perform an action defined by the instruction, the instruction including a control mode indicator, and wherein the executing the instruction includes:
checking the control mode indicator;
re-defining, based on the control mode indicator being a selected value, one or more instruction areas used by the instruction to provide other functionality of the instruction; and
performing the action defined by the instruction using at least a portion of the other functionality provided by the re-defining the one or more instruction areas.

13. The computer system of claim 12, wherein at least one instruction area of the one or more instruction areas is defined as to be ignored prior to the re-defining.

14. The computer system of claim 12, wherein the one or more instruction areas include one or more fields used by the instruction, and wherein the re-defining the one or more instruction areas includes changing one or more ignored bits of the one or more fields of the instruction to one or more usable bits.

15. The computer system of claim 12, wherein the one or more instruction areas include at least a portion of a storage area used by the instruction.

16. The computer system of claim 12, wherein the control mode indicator is set by a compiler at compile time.

17. A computer-implemented method comprising:
executing an instruction to perform an action defined by the instruction, the instruction including a control mode indicator, and wherein the executing the instruction includes:
checking the control mode indicator;
re-defining, based on the control mode indicator being a selected value, one or more instruction areas used by the instruction to provide other functionality of the instruction; and
performing the action defined by the instruction using at least a portion of the other functionality provided by the re-defining the one or more instruction areas.

18. The computer-implemented method of claim 17, wherein at least one instruction area of the one or more instruction areas is defined as to be ignored prior to the re-defining.

19. The computer-implemented method of claim 17, wherein the one or more instruction areas include one or more fields used by the instruction, and wherein the re-defining the one or more instruction areas includes changing one or more ignored bits of the one or more fields of the instruction to one or more usable bits.

20. The computer-implemented method of claim 17, wherein the one or more instruction areas include at least a portion of a storage area used by the instruction.

21. The computer-implemented method of claim 17, wherein the control mode indicator is set by a compiler at compile time.

22. A computer program product comprising:
a set of one or more computer-readable storage media; and
program instructions, collectively stored in the set of one or more computer-readable storage media, for causing at least one computing device to perform computer operations including:
executing an instruction to perform an action defined by the instruction, the instruction including a control mode indicator, and wherein the executing the instruction includes:
determining an execution mode of the instruction, based on the control mode indicator, the determining the execution mode comprising:
checking the control mode indicator; and
selecting the execution mode of the instruction from a plurality of execution modes based on a value of the control mode indicator; and
performing processing of the instruction based on the execution mode that is determined.

23. The computer program product of claim 22, wherein the plurality of execution modes includes a compatibility mode and an enhanced execution mode.

24. A computer-implemented method comprising:
executing an instruction to perform an action defined by the instruction, the instruction including a control mode indicator, and wherein the executing the instruction includes:
determining an execution mode of the instruction, based on the control mode indicator, the determining the execution mode comprising:
checking the control mode indicator; and
selecting the execution mode of the instruction from a plurality of execution modes based on a value of the control mode indicator; and
performing processing of the instruction based on the execution mode that is determined.

25. The computer-implemented method of claim 24, wherein the plurality of execution modes includes a compatibility mode and an enhanced execution mode.
